(19) United States
(12) Patent Application Publication
(10) Pub. No.: US 2004/0096300 A1
(43) Pub. Date: May 20, 2004

(54) Loadlock chamber

(76) Inventors: Ilya Perlov, Palo Alto, CA (US); Elena Drapkin, Palo Alto, CA (US)

Correspondence Address: Applied Materials Inc, Legal Affairs Department, Patent Counsel MS 2061, 3050 Bowers Avenue, Santa Clara, CA, 95054, US

(21) Appl. No.: 10/332,195

(22) PCT Filed: Jun. 30, 2001
(86) PCT No.: PCT/US01/41238

(51) Int. Cl. B65G 1/00

(52) U.S. Cl. 414/217

(57) ABSTRACT

In a first aspect, a loadlock chamber is provided that includes: (1) a first chamber portion adapted to remain stationary; (2) a second chamber portion adapted to move relative to the first chamber portion; and (3) a substrate handler located between the first and second chamber portions. The loadlock chamber is adapted to assume: (a) a closed position wherein the first and second chamber portions contact one another so as to define a region capable of maintaining a vacuum pressure; (b) an opened position wherein the second chamber portion moves away from the first chamber portion so as to define an opening; and (c) a load position wherein at least a portion of the substrate handler extends through the opening. Systems and methods in accordance with these and other aspects also are provided.

This application claims priority from U.S. Provisional patent application Ser. No. 60/217,144, filed Jul. 7, 2000, which is hereby incorporated by reference herein in its entirety.

### FIELD OF THE INVENTION

The present invention relates to semiconductor device manufacturing, and more particularly to an inventive loadlock chamber for use during semiconductor device manufacturing.

### BACKGROUND OF THE INVENTION

FIG. 1 is a schematic top plan view, in pertinent part, of a conventional processing system 11 having a factory interface wafer handler 13 adapted to transport wafers between a plurality of wafer carrier loading stations 15a-d and a processing tool 17. The exemplary processing system 11 shown in FIG. 1 includes an interface chamber 19 and the processing tool 17 which, in this example, comprises a pair of conventional loadlock chambers 23, a transfer chamber 25 coupled to the conventional loadlock chambers 23, and a plurality of processing chambers 27 coupled to the transfer chamber 25.

An interface wall 29 is positioned between the wafer carrier loading stations 15a-d and the processing system 11 for separating a “white area” clean room 31 from a less clean, “gray area” clean room 33. The wafer carrier loading stations 15a-d are located in the “white area” clean room 31 and the processing system 11 is located in the less clean, “gray area” clean room 33. The wafer carrier loading stations 15a-d are positioned adjacent sealable openings 35 in the interface wall 29. The wafer carrier loading stations 15a-d each comprise a wafer carrier platform (not shown) adapted to receive a sealed pod (not shown) and a wafer carrier opener 37 adapted to engage and unlatch a pod door (not shown) from the remainder of the pod as is known in the art.

The interface chamber 19 contains the interface wafer handler 13 mounted to a track (not shown). The transfer chamber 25 of the processing tool 17 contains a transfer chamber wafer handler 39 adapted to transport wafers (such as wafer W) between the loadlock chambers 23 and the processing chambers 27.

In operation, a pod (not shown), containing cassettes of wafers, is loaded onto one of the wafer carrier loading stations 15a-d; and the wafer carrier opener 37 engages and unlatches the pod door (not shown) of the pod. The wafer carrier opener 37 moves the pod door horizontally away from the wafer carrier platform (in the “X” direction in FIG. 1) and then moves the pod door vertically downward (into the page in FIG. 1) to provide clear access to the wafers in the pod. The interface wafer handler 13 of the interface chamber 19 then extracts a wafer from the pod and transports the wafer to one of the conventional loadlock chambers 23. Thereafter, the transfer chamber wafer handler 39 of the processing tool 17 transports the wafer from the conventional loadlock chamber 23 to one of the processing chambers 27 wherein a processing step is performed on the wafer.

While the conventional processing system 11 is highly effective, it is always desirable to reduce processing system footprint (e.g., to reduce clean room size requirements).

### SUMMARY OF THE INVENTION

In accordance with the present invention, an inventive loadlock chamber is provided that may reduce processing system footprint. In a first aspect of the invention, a loadlock chamber is provided that includes (1) a first chamber portion adapted to remain stationary; (2) a second chamber portion adapted to move relative to the first chamber portion; and (3) a substrate handler located between the first and second chamber portions. The loadlock chamber is adapted to assume (a) a closed position wherein the first and second chamber portions contact one another so as to define a region capable of maintaining a vacuum pressure; (b) an opened position wherein the second chamber portion moves away from the first chamber portion so as to define an opening; and (c) a load position wherein at least a portion of the substrate handler extends through the opening.

In a second aspect of the invention, a load lock chamber is provided that includes (1) a top portion adapted to remain stationary and that includes a first opening adapted to allow a substrate to be transferred to and from the loadlock chamber; (2) a bottom portion adapted to raise and lower relative to the top portion; and (3) a substrate handler located between the top and bottom portions. The loadlock chamber is adapted to assume (a) a closed position wherein the top and bottom portions contact one another so as to define a region capable of maintaining a vacuum pressure; (b) an opened position wherein the bottom portion and the substrate handler lower as a unit away from the top portion so as to define a second opening; (c) a load position wherein at least a portion of the substrate handler extends through the second opening; and (d) an unload position wherein the top and bottom portions contact one another and wherein at least a portion of the substrate handler extends through the first opening. Systems and methods in accordance with these and other aspects of the invention also are provided.

Other features and aspects of the present invention will become more fully apparent from the following detailed description, the appended claims and the accompanying drawings.

### BRIEF DESCRIPTION OF THE DRAWINGS

FIG. 1 is a schematic top plan view, in pertinent part, of a conventional processing system as previously described;

FIGS. 2A-D are schematic side sectional views of a novel processing system, showing an inventive loadlock chamber in a closed position, an opened position, a load position and an unload position, respectively;

FIG. 3 is a top view of the novel processing system of FIGS. 2A-D taken along line 3-3 in FIG. 2B; and

FIG. 4 is a top plan view of an exemplary embodiment of the transfer chamber of FIGS. 2A-3.

### DETAILED DESCRIPTION

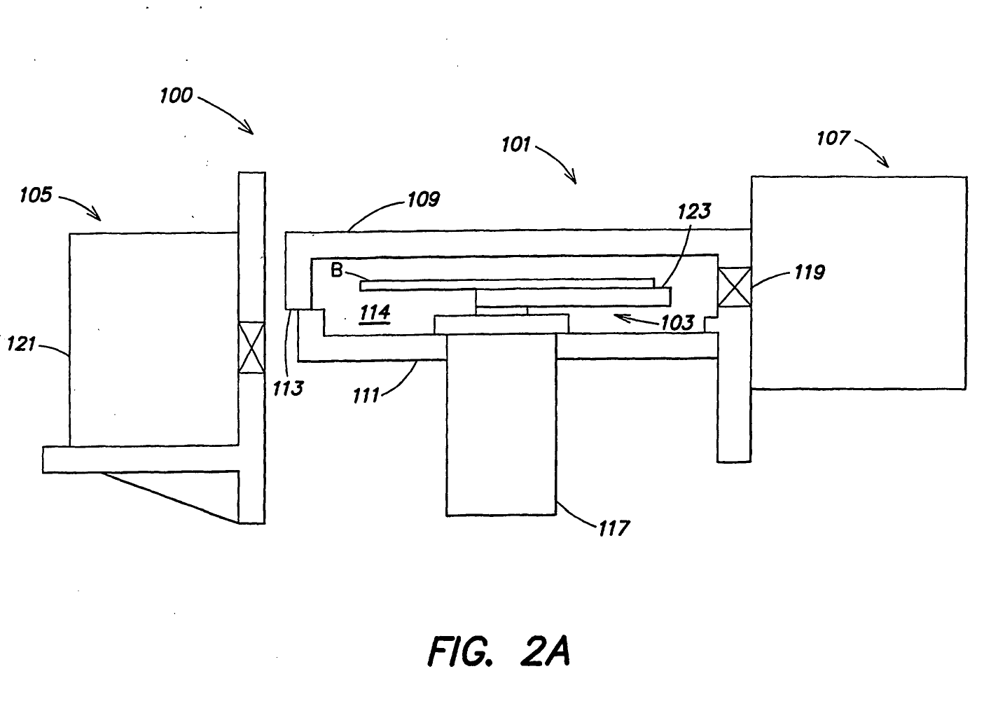

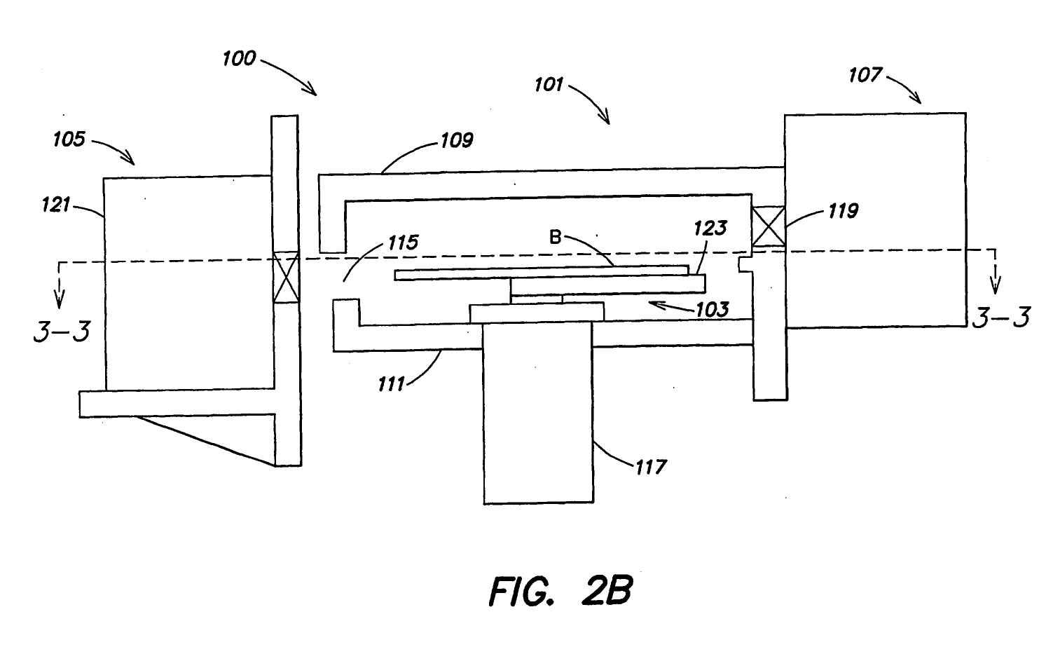

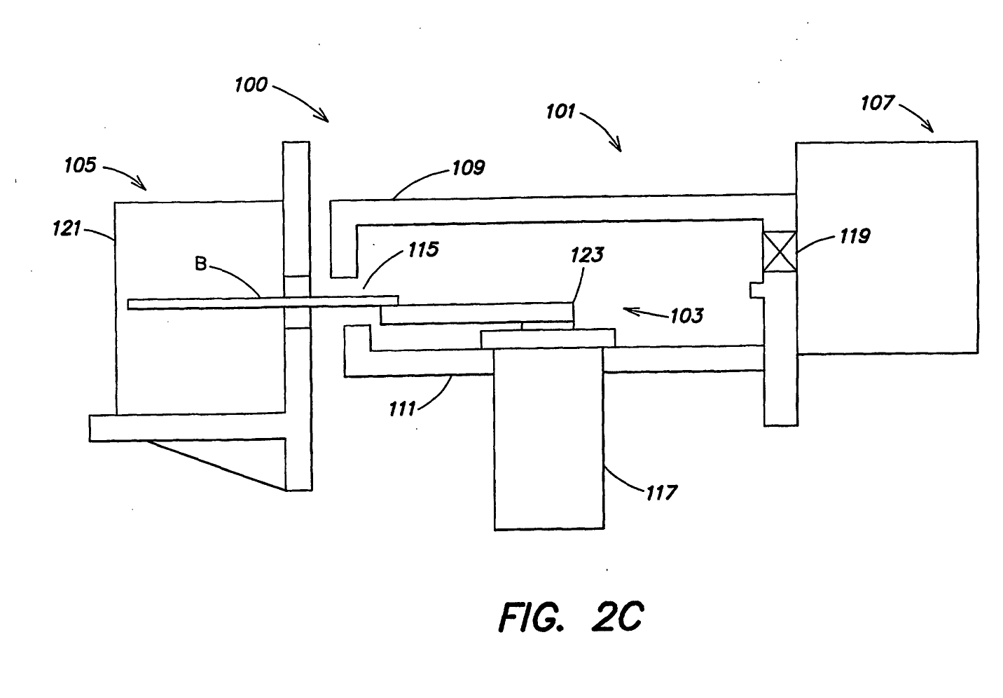

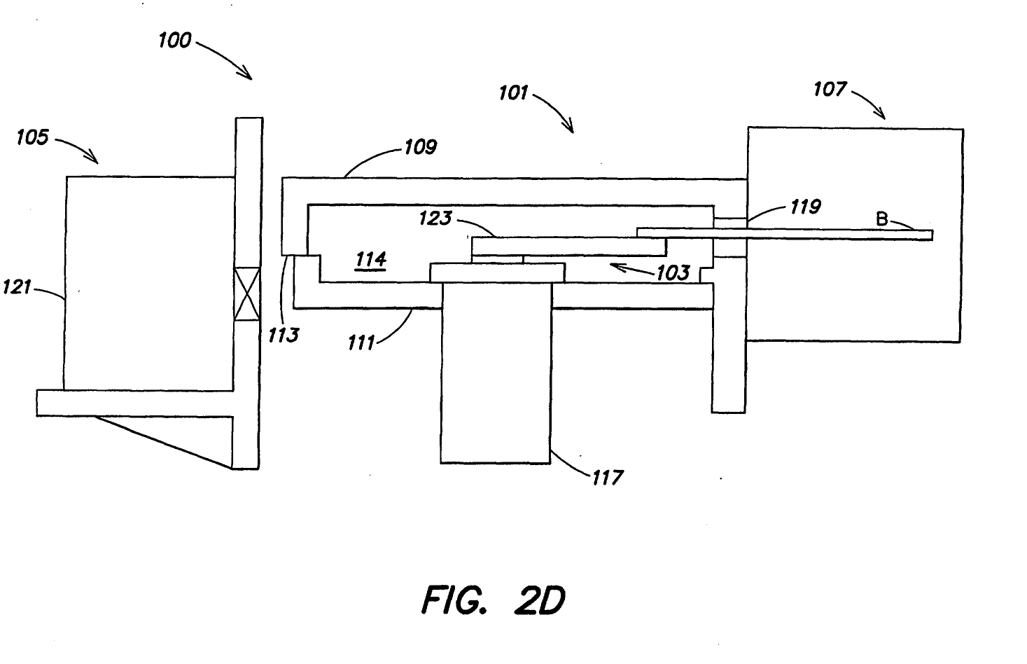

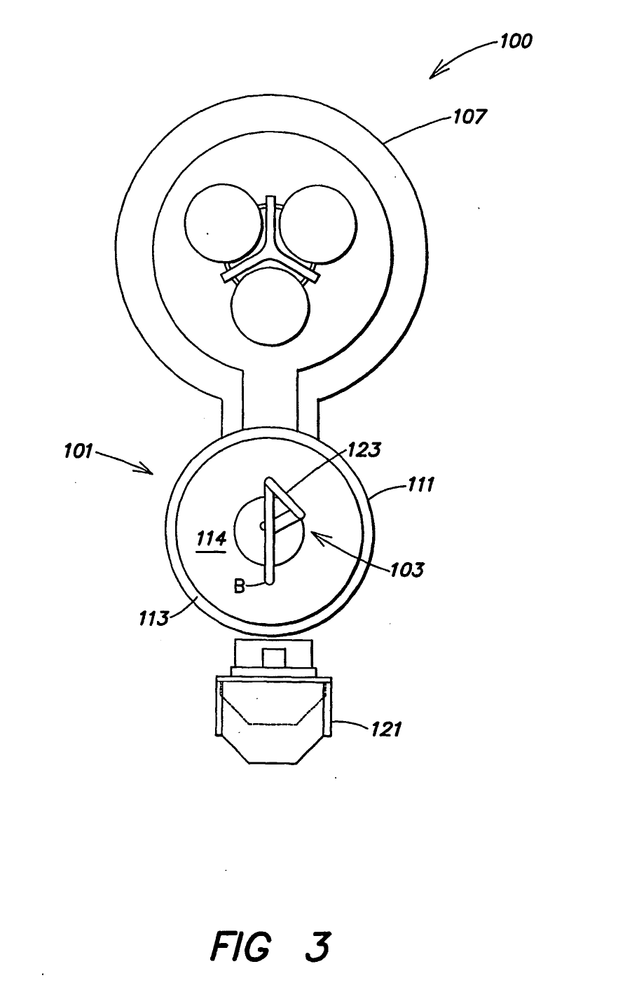

FIGS. 2A-D are schematic side sectional views of a novel processing system 100, showing an inventive loadlock chamber 101 in a closed position, an opened position, a load position and an unload position, respectively, and FIG. 3 is a top view of the novel processing system 100 taken along line 3-3 in FIG. 2B. The inventive loadlock chamber 101 contains a substrate handler 103 adapted to transfer a wafer (not shown) between a wafer carrier loading station 105 and a transfer chamber 107 of a processing tool (not shown).

The inventive loadlock chamber 101 comprises a stationary top plate 109 and a vertically moveable bottom plate 111. The top plate 109 and the bottom plate 111 are coupled so as to touch at an intersection surface 113 (FIG. 2A and FIG. 3). The top plate 109 and/or the bottom plate 111 may comprise an O-ring or the like (not shown) for forming a seal between the top plate 109 and the bottom plate 111 (e.g., a seal that is capable of withstanding/maintaining vacuum pressure in a region 114 formed between the top plate 109 and the bottom plate 111 as described below). The bottom plate 111 is mounted to the substrate handler 103, so as to move vertically therewith, such that when the substrate handler 103 moves vertically downward, the bottom plate 111 moves downward (FIG. 2B). When the bottom plate 111 is in the lowered position (FIG. 2B), the loadlock chamber 101 is in an “opened” position, and a blade B of the substrate handler 103 is adjacent an opening 115 created between the stationary top plate 109 and the lowered bottom plate 111. The substrate handler 103 may be raised and/or lowered via a vertical actuator such as a motor 117.

The operation of the inventive loadlock chamber 101 is described with reference to the sequential views of FIGS. 2A-D, which show the inventive loadlock chamber 101 in the closed, opened, load and unload positions, respectively.

In operation, from the closed position (FIG. 2A) the motor 117 is energized and moves the substrate handler 103 downward, carrying the bottom plate 111 therewith. As the substrate handler 103 moves downward, the opening 115 is created between the stationary top plate 109 and the bottom plate 111, which is attached to and moves downward with the substrate handler 103. The inventive loadlock chamber 101 is then in the opened position as shown in FIG. 2B. The blade B of the substrate handler 103 moves horizontally and extends to a position beneath a wafer (not shown) contained within a pod 121 positioned on the wafer carrier loading station 105. The inventive loadlock chamber 101 is then in the load position as shown in FIG. 2C. The blade B of the substrate handler 103 lifts slightly (so as to pick up the wafer), retracts and carries the wafer into the inventive loadlock chamber 101 (FIG. 2B). Alternatively, the substrate handler 103 may remain stationary while the pod 121 (or a wafer support therein) indexes downward to place a wafer on the substrate handler 103. The blade B of the substrate handler 103 then may retract so as to carry the wafer into the inventive loadlock chamber 101 (FIG. 2B).

After a wafer is retrieved, the motor 117 elevates the substrate handler 103, carrying the wafer and the bottom plate 111 vertically upward such that the bottom plate 111 again contacts and seals against the stationary top plate 109. Thus, the opening 115 is closed, as shown in FIG. 2A (creating the sealed region 114). Thereafter, the inventive loadlock chamber 101 is pumped down to a desired vacuum level. An arm 123 of the substrate handler 103 rotates 180 degrees so as to place the blade B adjacent a slit valve 119. The slit valve 119 then opens and the substrate handler 103 extends so as to transfer the wafer into the transfer chamber 107 through the slit valve 119 (placing the inventive loadlock chamber 101 in the unload position as shown in FIG. 2D).

In one aspect, the opening 115 may be created at a lower elevation than the elevation of the slit valve 119; accordingly the wafer carrier loading station 105 may be positioned at a lower elevation than the transfer chamber 107. Thus when the substrate handler 103 and the bottom plate 111 lower so as to open the inventive loadlock chamber 101, the substrate handler 103 is positioned adjacent (e.g., at the same elevation as) the wafer carrier loading station 105, and when the substrate handler 103 and the bottom plate 111 raise so as to close the inventive loadlock chamber 101, the substrate handler 103 is positioned adjacent (e.g., at the same elevation as) the transfer chamber 107.

Alternatively, the opening 115 may be created at the same elevation as the slit valve 119 (so that the wafer carrier loading station 105 and the transfer chamber 107 may be located at the same level).

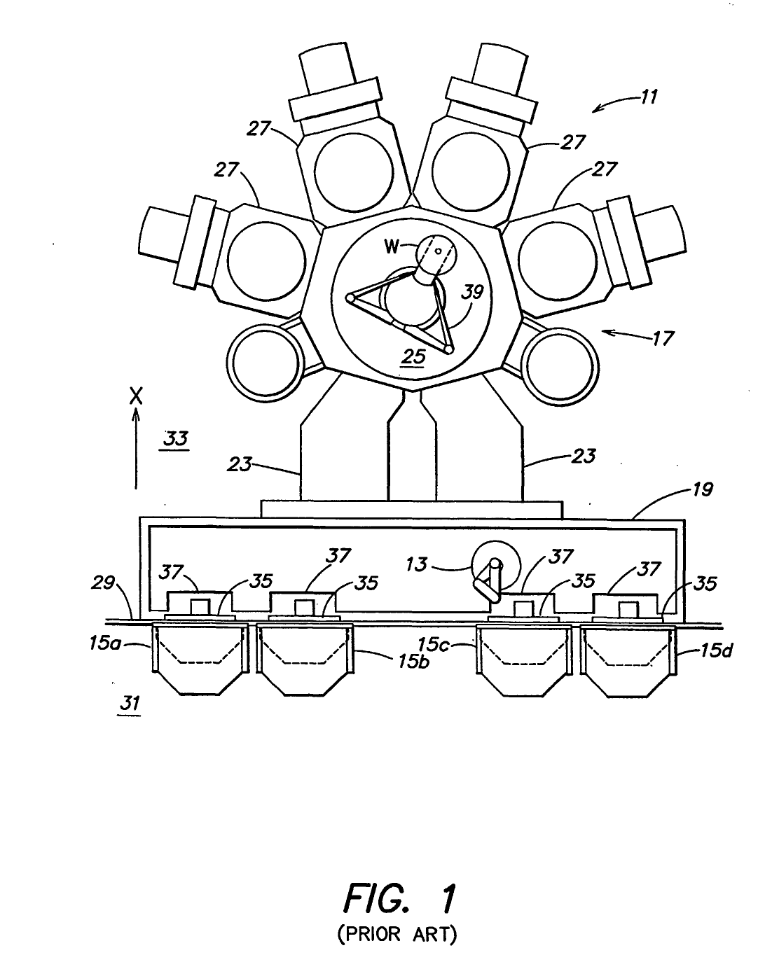

As can be seen from FIGS. 2A-3, the novel processing system 100 occupies a smaller footprint than the conventional processing system 11 of FIG. 1 (e.g., as the interface chamber 19 is not required).

Note that the slit valve 119 may be, for example, the slit valve disclosed in U.S. Provisional patent application Ser. No. 60/216,868, filed Jul. 7, 2000 (AMAT Docket No. 4514/L/ATD/MBE titled “Automatic Slit/Gate Valve”) which is hereby incorporated by reference herein in its entirety, and the transfer chamber 107 may be, for example, the transfer chamber disclosed in U.S. patent application Ser. No. 09/611,549, filed Jul. 7, 2000 (AMAT Docket No. 1259/P2/ATD/DV titled “Method and Apparatus For Improved Substrate Handling”) which is hereby incorporated by reference herein in its entirety.

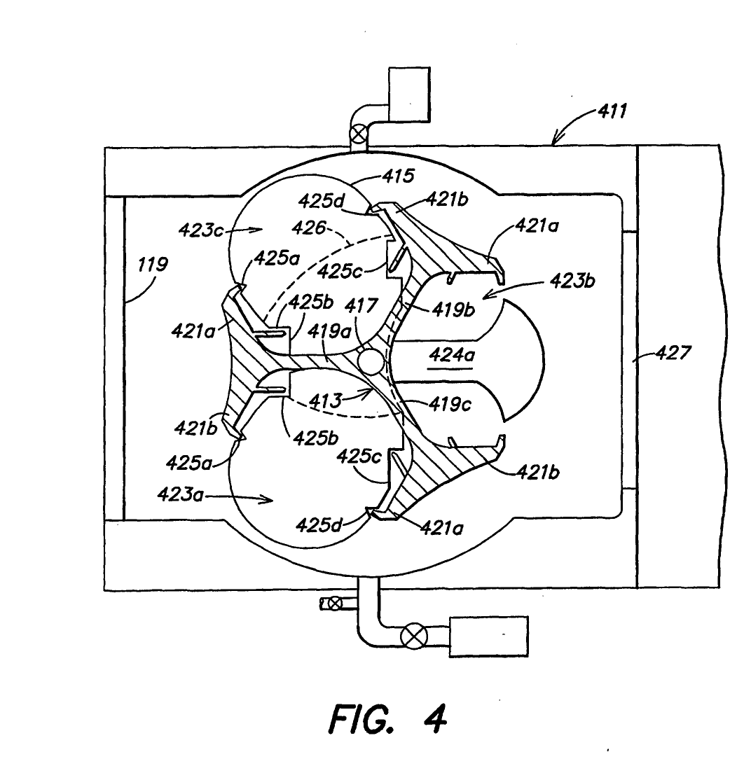

FIG. 4 is a top plan view of a transfer chamber 411 containing a substrate carriage 413 and temperature adjustment plate 415 that represents one exemplary embodiment of the transfer chamber 107 of FIGS. 2A-3. The transfer chamber 411 is described in further detail in previously incorporated U.S. patent application Ser. No. 09/611,549.

With reference to FIG. 4, the transfer chamber 411 includes a central shaft 417 fixedly coupled to the temperature adjustment plate 415 and that extends therefrom through a center region of the substrate carriage 413. Preferably the central shaft 417 is not in contact with the center region of the substrate carriage 413, but rather is coupled to the substrate carriage 413 via a motor (not shown). The substrate carriage 413 comprises three equally spaced branches 419a-c which extend radially outward from the center region of the substrate carriage 413. Each branch 419a-c comprises a pair of substrate supports 421a-b which face outwardly (i.e., away from each other) therefrom. The branches 419a-c are preferably machined from the same piece of material or may be made of two or more separate parts connected together using bolts, screws or other connectors including welding, such that they rotate and/or elevate together as a unit. The branches 419a-c and the substrate supports 421a (e.g., of a first branch 419a) and 421b (e.g., of a second branch 419b) are configured so as to define a plurality of substrate seats 423a-c each of which supports a substrate (not shown) by its edge. By placing a substrate (not shown) on a pair of substrate supports 421a-b secured to adjacent branches (e.g., branches 419a, 419b, branches 419a, 419c or branches 419b, 419c) a passage is maintained for a substrate handler blade 424a of a substrate handler (not shown) to pass therethrough during substrate handoffs between the substrate carriage 413 and the substrate handler blade 424a, as described further below.

The substrate supports 421a-b are preferably made of a ceramic such as alumina, quartz or any other hard material which is compatible with semiconductor substrates and does not produce particles or scratch a substrate during contact therewith. The substrate supports 421a-b are attached to the underside of the branches 419a-c, such that the substrate carriage 413 may lower the substrate supports 421a-b below the top surface of the temperature adjustment plate 415, and below the substrate handler blade 424a, thus transferring a substrate supported by a substrate seat 423a-c to the temperature adjustment plate 415 and/or to the substrate handler blade 424a, while the remainder of the substrate carriage 413 (i.e., the branches 419a-c) remains above and does not contact either the temperature adjustment plate 415 and/or the substrate handler blade 424a.

The temperature adjustment plate 415 is configured to simultaneously support two substrates (not shown), when the substrate carriage 413 lowers the substrate supports 421a-b to an elevation below the top surface of the temperature adjustment plate 415. In order to achieve uniform heating or cooling across the entire substrate surface, the temperature adjustment plate 415 is preferably coextensive with the substrates placed thereon. Thus, in order to allow the substrate supports 421a-b to lower to an elevation below that of the top surface of the temperature adjustment plate 415, the temperature adjustment plate 415 includes four notches 425a-d placed to receive the substrate supports 421a-b. Preferably the temperature adjustment plate 415 also comprises a cut out region 426 in which the substrate handler (not shown) may be housed. The cut out region 426 is configured to provide sufficient space for the substrate handler to swing about a central axis when the substrate handler extends and retracts without interfering engagement with a heating plate 415a.

In operation the substrate carriage 413 positions one of the substrate support seats 423a-c adjacent the slit valve 119 and lowers. The slit valve 119 opens and the blade B of the substrate handler 103 extends therethrough carrying a wafer to a position above the substrate support seat 423a-c adjacent the slit valve 119. The substrate carriage 413 elevates, lifting the wafer from the blade B onto the substrate support seat 423a-c. The blade B retracts, the loadlock chamber 101 assumes the closed position (FIG. 2A) and the substrate carriage 413 rotates to position the wafer adjacent a slit valve 427. The substrate carriage 413 then lowers transferring the wafer to the blade 424a. The slit valve 427 opens and the blade 424a extends therethrough to place the wafer into another chamber (not shown) coupled to the transfer chamber 411, such as a processing chamber. The wafer may be heated or cooled via the temperature adjustment plate 415 prior to wafer transfer as described in U.S. patent application Ser. No. 09/611,549.

The foregoing description discloses only exemplary embodiments of the invention. Modifications of the above-disclosed apparatus and method which fall within the scope of the invention will be readily apparent to those of ordinary skill in the art. For instance, the inventive load lock chamber 101 may be configured such that the top plate 109 moves up and down rather than the bottom plate 111 and/or the substrate handler 103. The particular shapes of the top plate 109 and the bottom plate 111 are merely exemplary, and other shapes may be employed. Other mechanisms may be employed to raise and lower the bottom plate 111 and the substrate handler 103, and the bottom plate 111 and substrate handler 103 may be raised and lowered independently if desired. Other types of substrate handlers may be employed within the inventive loadlock chamber 101.

Accordingly, while the present invention has been disclosed in connection with the exemplary embodiments thereof, it should be understood that other embodiments may fall within the spirit and scope of the invention, as defined by the following claims.

What is claimed is:

1. A loadlock chamber comprising:
a first chamber portion adapted to remain stationary;
a second chamber portion adapted to move relative to the first chamber portion; and
a substrate handler located between the first and second chamber portions;
wherein the loadlock chamber is adapted to assume:
(a) a closed position wherein the first and second chamber portions contact one another so as to define a region capable of maintaining a vacuum pressure;
(b) an opened position wherein the second chamber portion moves away from the first chamber portion so as to define an opening; and
(c) a load position wherein at least a portion of the substrate handler extends through the opening.

2. The loadlock chamber of claim 1 wherein the first chamber portion is an upper chamber portion and wherein the second chamber portion is a lower chamber portion that is adapted to raise and lower relative to the first chamber portion.

3. The loadlock chamber of claim 2 wherein the second chamber portion and the substrate handler are adapted to raise and lower as a unit relative to the first chamber portion.

4. The loadlock chamber of claim 2 wherein the opened position is a position wherein the second chamber portion is lowered from the first chamber portion.

5. The loadlock chamber of claim 1 wherein the substrate handler includes a blade adapted to support a substrate and to extend through the opening and extract a substrate from a substrate loading station when the loadlock chamber is in the load position.

6. The loadlock chamber of claim 1 wherein:
at least one of the first and the second chamber portions includes a chamber opening adapted to allow a substrate to be transferred to and from the loadlock chamber; and
the loadlock chamber is adapted to assume an unload position wherein the first and the second chamber portions contact one another and wherein at least a portion of the substrate handler extends through the chamber opening.

7. The loadlock chamber of claim 6 wherein the chamber opening comprises a slit valve.

8. The loadlock chamber of claim 6 wherein the substrate handler includes a blade adapted to support a substrate and to extend through the chamber opening and transfer a substrate to a transfer chamber.

9. A system comprising the loadlock chamber of claim 6 coupled to a transfer chamber.

10. A loadlock chamber comprising:
a first chamber portion adapted to remain stationary;
a second chamber portion adapted to move relative to the first chamber portion, wherein at least one of the first and the second chamber portions includes a first opening adapted to allow a substrate to be transferred to and from the loadlock chamber; and
a substrate handler located between the first and second chamber portions;
wherein the loadlock chamber is adapted to assume:
(a) a closed position wherein the first and second chamber portions contact one another so as to define a region capable of maintaining a vacuum pressure;
(b) an opened position wherein the second chamber portion moves away from the first chamber portion so as to define a second opening;
(c) a load position wherein at least a portion of the substrate handler extends through the second opening; and
(d) an unload position wherein the first and the second chamber portions contact one another and wherein at least a portion of the substrate handler extends through the first opening.

11. A loadlock chamber comprising:
a top portion adapted to remain stationary;
a bottom portion adapted to raise and lower relative to the first portion; and
a substrate handler located between the top and bottom portions;
wherein the loadlock chamber is adapted to assume:
(a) a closed position wherein the top and bottom portions contact one another so as to define a region capable of maintaining a vacuum pressure;
(b) an opened position wherein the bottom portion lowers from the top portion so as to define an opening; and
(c) a load position wherein at least a portion of the substrate handler extends through the opening.

12. A loadlock chamber comprising:
a top portion adapted to remain stationary and that includes a first opening adapted to allow a substrate to be transferred to and from the loadlock chamber;
a bottom portion adapted to raise and lower relative to the top portion; and
a substrate handler located between the top and bottom portions;
wherein the loadlock chamber is adapted to assume:
(a) a closed position wherein the top and bottom portions contact one another so as to define a region capable of maintaining a vacuum pressure;
(b) an opened position wherein the bottom portion and the substrate handler lower as a unit away from the top portion so as to define a second opening;
(c) a load position wherein at least a portion of the substrate handler extends through the second opening; and
(d) an unload position wherein the top and bottom portions contact one another and wherein at least a portion of the substrate handler extends through the first opening.

13. A system comprising the loadlock chamber of claim 12 coupled to a transfer chamber.

14. The system of claim 12 wherein the first opening is at a lower elevation than the second opening.

15. The system of claim 12 wherein the first opening is at the same elevation as the second opening.

16. A method comprising:
providing a loadlock chamber having:
a first chamber portion adapted to remain stationary;
a second chamber portion adapted to move relative to the first chamber portion; and
a substrate handler located between the first and second chamber portions;
moving the second chamber portion away from the first chamber portion to define a first opening;
retrieving a substrate from a substrate loading station with the substrate handler;
moving the second chamber portion into contact with the first chamber portion so as to define a sealed region; and
evacuating the sealed region.

17. The method of claim 16 wherein retrieving a substrate from a substrate loading station with the substrate handler comprises:
extending at least a blade of the substrate handler through the first opening;
retrieving a substrate from a substrate loading station with the blade; and
retracting the blade of the substrate handler.

18. The method of claim 16 further comprising:
extending at least the blade of the substrate handler through a second opening in the loadlock chamber and into a transfer chamber coupled to the loadlock chamber; and
transferring the substrate from the blade to the transfer chamber.

19. A method comprising:
providing a loadlock chamber having:
a first chamber portion adapted to remain stationary;
a second chamber portion adapted to move relative to the first chamber portion; and
a substrate handler located between the first and second chamber portions;
moving the second chamber portion away from the first chamber portion to define a first opening;
extending at least a blade of the substrate handler through the first opening;
retrieving a substrate from a substrate loading station with the blade;
retracting the blade of the substrate handler;
moving the second chamber portion into contact with the first chamber portion so as to define a sealed region;
evacuating the sealed region;
extending at least the blade of the substrate handler through a second opening in the loadlock chamber and into a transfer chamber coupled to the loadlock chamber; and
transferring the substrate from the blade to the transfer chamber.

20. A method comprising:
providing a loadlock chamber having:
a top portion adapted to remain stationary;
a bottom portion adapted to move relative to the top portion; and
a substrate handler located between the top and bottom portions;
lowering the bottom portion away from the top portion to define a first opening;
retrieving a substrate from a substrate loading station with the substrate handler;
raising the bottom portion into contact with the top portion so as to define a sealed region; and
evacuating the sealed region.

21. A method comprising:
providing a loadlock chamber having:
a top portion adapted to remain stationary;
a bottom portion adapted to move relative to the top portion; and
a substrate handler located between the top and bottom portions;
lowering the bottom portion and the substrate handler as a unit away from the top portion to define a first opening;
extending at least a blade of the substrate handler through the first opening;
retrieving a substrate from a substrate loading station with the blade;
retracting the blade of the substrate handler;
raising the bottom portion and the substrate handler as a unit so that the bottom portion contacts the top portion and the top and bottom portions define a sealed region;
evacuating the sealed region;
extending at least the blade of the substrate handler through a second opening in the loadlock chamber and into a transfer chamber coupled to the loadlock chamber; and
transferring the substrate from the blade to the transfer chamber.
